(19) United States
(12) Patent Application Publication
(10) Pub. No.: US 2004/0254662 A1
(43) Pub. Date: Dec. 16, 2004

(54) Encoded system for recording music and the like

(76) Inventor: Charles H. Cook, JR., Allen, TX (US)

Correspondence Address: Michael A. O'Neil, Michael A. O'Neil, P.C., 5949 Sherry Lane, Suite 820, Dallas, TX, 75225, US

(21) Appl. No.: 10/853,388

(22) Filed: May 25, 2004

Related U.S. Application Data
(60) Provisional application No. 60/473,831, filed on May 27, 2003.

(51) Int. Cl. G11B 7/00; G06F 17/00

(52) U.S. Cl. 700/94

(57) ABSTRACT

An encoded recordable medium includes a programmable read only memory adapted to receive a predetermined code, a storage memory, and a connector for electrically connecting the programmable read only memory and the storage memory to a computer. The computer employs the facilities the internet to establish a connection between a content provider and the encoded recordable medium. The content provider first queries the programmable read only memory of the encoded recordable medium to determine if the required code is present. If so, music and other content items are downloaded from the content provider over the internet through the computer and are stored in the storage memory of the encoded recordable medium.

### CLAIM OF PRIORITY

This application claims priority of prior provisional Application Ser. No. 60/473,831 filed May 27, 2003.

### TECHNICAL FIELD

This invention relates generally to the recording of music and other content using the facilities of the internet, and more particularly to a system in which the recording medium is encoded to facilitate authorized recordings while preventing unauthorized recordings.

### BACKGROUND AND SUMMARY OF THE INVENTION

The use of the internet for the transmission of recordable music and other recordable content is well known. Also well known are the legal difficulties that have arisen from the use of the internet to transmit copyrighted materials without first obtaining permission from the copyright owners.

The present invention overcomes the foregoing and other difficulties which have long since characterized the prior art by facilitating the recording of music and other content received over the internet while preventing the unauthorized recording thereof. In accordance with the broader aspects of the invention, the medium which is utilized to record music and other content received over the internet is encoded. Whenever an attempt is made to record music and other content available over the internet, the medium upon which the recording will be made is first queried electronically to determine if the required code is present. If not, the requested music or other content is not transmitted. Conversely, if the required is code is detected, the requested music or other content is transmitted and is recorded onto the coded recordable medium.

In accordance with another aspect of the invention, the encoding resident in the recordable medium can be used to regulate the amount of material to be recorded thereon. For example, the recording can be limited to a specific number of songs or other items of content. Recording can also be limited to a specified time duration, i.e., minutes of recording. Recording can also be limited to a certain time period such as a specific number of days, weeks, etc. Recording can also be entirely unlimited.

The present invention contemplates the purchase of the encoded recordable medium with the purchase price including compensation to owners of copyrights in the materials to be recorded. Thus, the price to be charged for the encoded recordable medium depends at least to a certain extent on the amount of music or other content to be recorded thereon. For example, the purchase price of an encoded recordable medium coded to permit the recording of only a few songs or other content items would be relatively low as compared with the purchase price of a encoded recordable medium coded to permit unlimited recording.

Yet another aspect of the invention involves removable of the encoded recordable medium from the computer or other device used to effect recording. Following such removal, the encoded recordable medium now having songs or other content items recorded thereon is engaged with a port adapted to receive the encoded recordable medium and connected to a suitable playback device. In this manner play back of songs and other content items previously recorded on the coded recordable medium can be made through automotive entertainment systems, portable entertainment systems, entertainment systems of the type utilized in homes and offices, etc.

### BRIEF DESCRIPTION OF THE DRAWINGS

A more complete understanding of the present invention may be had by reference to the following Detailed Description when taken in connection with the accompanying Drawings, wherein:

FIG. 1 is a diagrammatic illustration of a computer utilized to facilitate the recording of songs and other content items received over the internet on the encoded recordable medium of the present invention;

FIG. 2 is a top view of the preferred embodiment of the encoded recordable medium of the present invention;

FIG. 3 is an illustration of an automotive entertainment system equipped to play back songs and other content items recorded on the encoded recordable medium of the present invention;

FIG. 4 is an illustration of a portable entertainment system equipped to play back songs and other content items recorded on the encoded recordable medium of the present invention;

FIG. 5 is an illustration of one component of an entertainment system of the type utilized in homes and offices which is equipped to play back songs and other content items recorded on the encoded recordable medium of the present invention; and

FIG. 6 is a flowchart illustrating the use of the encoded recordable medium of the present invention to record songs and other content received over the internet and to effect playback thereof.

### DETAILED DESCRIPTION

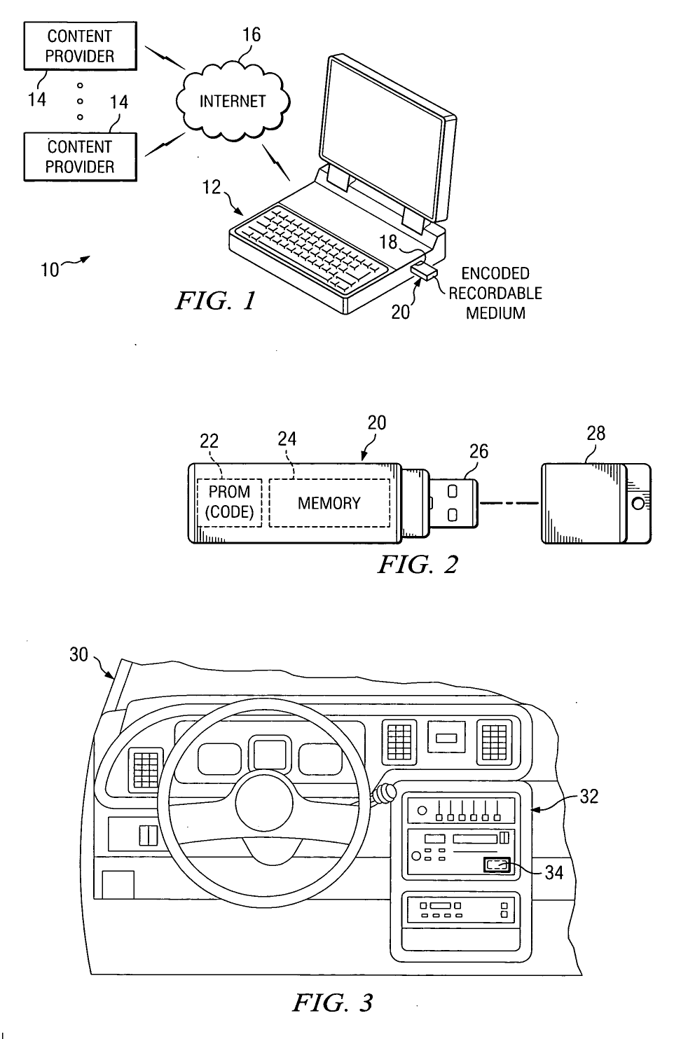

Referring now to the Drawings, and particularly to FIG. 1 thereof, there is shown a system 10 for recording music and other recordable content utilizing the encoded recordable medium of the present invention. A computer 12 is connected to a plurality of content providers 14 utilizing the facilities of the internet 16. The computer 12 may comprise any type or kind of computer, including but not limited to a palm top computer, a laptop computer, a desk top computer, a workstation comprising part of a large computer system, etc. Regardless of the type or kind of computer that is utilized in the practice of the invention, the computer 12 includes a port 18 which receives an encoded recordable medium 20 comprising the present invention.

Referring to FIG. 2, the encoded recordable medium 20 of the present invention is further illustrated. The encoded recordable medium 20 includes a programmable read only memory (PROM) which contains a predetermined code. The encoded recordable medium 20 further includes a storage memory 24 which is utilized to record music and other content received over the internet. The encoded recordable medium 20 further comprises a male connector component 26 which is utilized to establish electrical connections between the encoded recordable medium 20 and a female connector component 28. The female connector component 28 is in turn electrically connected to the internal components of either a recording device, or a playback device, or a combined recording/playback device.

The particular encoded recordable medium illustrated in FIG. 2 is of the type known as a thumb drive. As will be appreciated by those skilled in the art, the present invention is not limited to use in conjunction with thumb drive devices, but instead is adaptable and applicable to a wide variety of recordable media. Thus, the present invention is equally adaptable to any device which is engagable with a suitable computer to record music and other content received over the internet and which is disengagable from the computer following recording to effect playback. Examples of presently available devices which may be utilized in the practice of the invention include various types of recordable tapes, floppy disks, compact disks, DVD's, etc.

Following the recording of music or other content items on the encoded recordable medium 20 of the present invention the encoded recordable medium 20 is removed from the computer 12 and is transferred to a playback device to effect play back of whatever has previously been recorded on the encoded recordable medium 20. For example, FIG. 3 illustrates an automobile 30 having an entertainment system 32. The entertainment system 32 includes a port 34 adapted to receive and establish electrical connections to the encoded recordable medium 20. After the encoded recordable medium 20 has been engaged with the port 34 of the entertainment system 32, the entertainment system 32 is used to effect playback of the contents of the storage memory 24 of the encoded recordable medium 20.

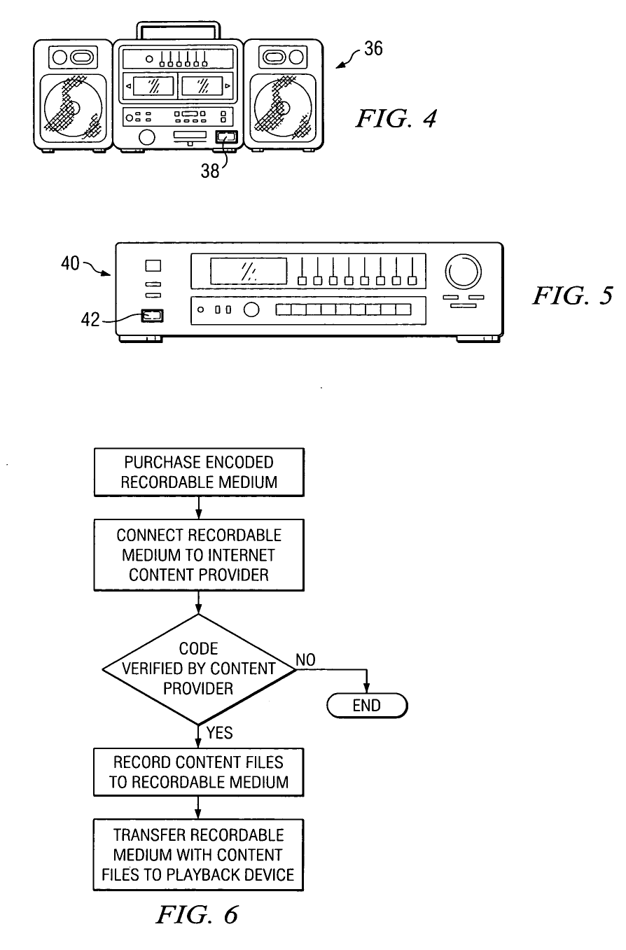

FIG. 4 illustrates a portable entertainment system 36 having the port 38 adapted to receive and establish electrical connections with the encoded recordable medium 20 of the present invention. Following engagement of the encoded recordable medium 20 of the present invention with the port 38 of the portable entertainment system 36 the portable entertainment 36 is utilized to effect playback of the contents of the memory 24 of the encoded recordable medium 20.

FIG. 5 illustrates a component 40 of a home/office type entertainment system 40. The component 40 has a port 42 adapted to receive and establish electrical connections with the encoded recordable medium 20 of the present invention. Following engagement of the encoded recordable medium 20 of the present invention with the port 42 of the component 40 the home/office type entertainment is utilized to effect playback of the contents of the storage memory 24 of the encoded recordable medium 20.

The present invention will be further appreciated by reference to the flowchart of FIG. 6. A customer purchases the encoded recordable medium of the present invention either from a retailer or online. Referring momentarily to FIG. 2, the PROM 22 comprising the encoded recordable medium 20 may be programmed to limit the amount of recording that is permitted on a particular encoded recordable medium 20. For example, recording may be limited to a predetermined number of songs or other content items. Alternatively, recording may be limited to a predetermined time duration, i.e., minutes of recording. Recording may also be limited to a certain time period, such as a predetermined number of days or weeks. Recording can also be unlimited other than by the maximum content of the memory 24 of the encoded recordable medium 20. As will be appreciated by those skilled in the art, the price point at which the encoded recordable medium 20 is purchased depends to a large extent on the restrictions that are placed on the amount of content that can be recorded thereon.

After the encoded recordable medium 20 has been purchased, it is connected to a content provider utilizing the facilities of the internet. This is accomplished by connecting the encoded recordable medium 20 to a suitable computer utilizing a port embedded in the computer which is adapted to receive and establish electrical connections to the encoded recordable medium 20. As is well known by those skilled in the art, most modern computers are adapted to receive and establish operating connections to a wide variety of recordable media all of which are adapted to be encoded in accordance with the present invention.

After the encoded recordable medium of the present invention has been connected to a suitable computer and a link between the computer and a content provider has been established utilizing the facilities of the internet the content provider electronically queries the encoded recordable medium of the present invention to determine whether the required code is present. If the required code is not present, the process ends and no recording is made. Conversely, if the required code is present, recording commences and continues within the parameters established by the coding resident within the PROM 22 of the encoded recordable medium 20.

After the desired recording has been completed, the encoded recordable medium 20 is disengaged from the computer and is transferred to a suitable playback device. Examples of various playback devices which may be utilized in the practice of the invention are illustrated in FIGS. 3, 4, and 5 and described hereinabove in connection therewith. The selected playback device is thereafter utilize to play back some or all of the content recorded on the encoded recordable medium of the present invention.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. An encoded recordable medium comprising:
a programmable read only memory for receiving and storing a predetermined code;
a memory for receiving and storing music and other content items received over the internet upon recognition of the code stored in the programmable read only memory; and
connector means for establishing electrical connection between a computer and both the programmable read only memory and the storage memory.

2. The encoded recordable medium of claim 1 which comprises a thumb drive.

3. The encoded recordable medium of claim 1 which comprises a recordable tape.

4. The encoded recordable medium of claim 1 which comprises a floppy disk.

5. The encoded recordable medium of claim 1 which comprises a compact disk.

6. The encoded recordable medium of claim 1 which comprises a DVD.

7. The encoded recordable medium of claim 1 further including a playback device for establishing an electrical connection with the component of the recordable medium comprising the memory for receiving and storing music and other content and for effecting playback of the music and other recordable content.

8. A system for effecting recording of music and other content items received over the internet comprising:
providing an encoded recordable medium including a programmable read only memory for receiving a predetermined code, a storage memory for recording music and other content items received over the internet, and a connector for electrically connecting both the programmable read only and the storage memory to a computer;
providing a computer adapted to receive the encoded recordable medium and to establish electrical connections with the programmable read only memory and the storage memory thereof;
utilizing the computer to establish a connection between encoded recordable medium and a content provider utilizing the facilities of the internet;
initially establishing an electrical connection between the content provider and the programmable read only memory of the encoded recordable medium whereby the content provider verifies the presence of a predetermined code stored within the read only programmable memory; and
thereafter establishing an electrical connection between the content provider and the storage memory of the encoded recordable medium whereby music and other content items are transferred from the content provider over the internet through the computer to the storage memory of the encoded recordable medium.

9. The system for effecting recording of music and other content received over the internet according to claim 8 wherein the step of providing an encoded recordable medium is carried out by providing a thumb drive.

10. The system for effecting recording of music and other content received over the internet according to claim 8 wherein the step of providing an encoded recordable medium is carried out by providing a recordable tape.

11. The system for effecting recording of music and other content received over the internet according to claim 8 wherein the step of providing an encoded recordable medium is carried out by providing a floppy disc.

12. The system for effecting recording of music and other content received over the internet according to claim 8 wherein the step of providing an encoded recordable medium is carried out by providing a compact disc.

13. The system for effecting recording of music and other content received over the internet according to claim 8 wherein the step of providing an encoded recordable medium is carried out by providing a DVD.

14. The system for effecting recording of music and other content received over the internet according to claim 8 including the subsequent steps of:
providing a playback device;
establishing an electrical connection between the playback device and the storage memory of the encoded recordable medium; and
thereafter utilizing the playback device to play back content recorded on the storage memory of the encoded recorded medium.
